(19) United States
(12) Patent Application Publication
(10) Pub. No.: US 2011/0151205 A1
(43) Pub. Date: Jun. 23, 2011

(54) SYSTEM AND METHODOLOGY FOR NUTRITIONAL PACKAGING

(76) Inventors: Richard T. Klauser, Upper Saddle River, NJ (US); Lesley Keane Verdi, Chester, NJ (US); Lynn Belote, Denville, NJ (US); Thomas Joseph James, Franklin Park, NJ (US)

(21) Appl. No.: 12/988,865

(22) PCT Filed: Apr. 28, 2009
(86) PCT No.: PCT/US09/41972

§ 371 Date: Feb. 15, 2011

Related U.S. Application Data
(60) Provisional application No. 61/048,384, filed on Apr. 28, 2008.

(51) Int. Cl. B32B 37/22; B32B 3/14

(52) U.S. Cl. 428/195.1; 156/299

(57) ABSTRACT

Systems and methodologies for facilitating the proper case and feeding of children or others by parents or caregivers. Through visual cues on products, juxtaposed with corresponding textual descriptors, and color-coding, the technique of the present invention provides a ready tool to identify appropriate foods. Additionally, a ring protocol establishes a way to assure that not only appropriate foods are consumed but in an appropriate percentage and amount, thereby assuring parents and other caregivers that their charges are properly fed.

### BACKGROUND OF THE INVENTION

The care and feeding of children, including infants and toddlers weighs heavily on parents the odd over. Where one or perhaps both parents work, the time demands on parents are considerable. It is the goal, however, of every parent, whether pressured or not, to provide the best possible sustenance to their child. Similarly, other caregivers are hard-pressed to best serve their charges.

With modern times, the advantages of enhanced knowledge about nutrition and other health advantages and disadvantages of particular foods and food groups cause more anxiety among some parents. Much literature has been published about the timing and types of foods suitable for children at various stages of development. Parents, already besieged with the basic demands, are often unable to research more particular dietary requirements for their child during each discrete phase of growth. If a number of children are being raised together, then there is the concern of mixing one nutritional regimen for another, thereby causing further parental anxiety and perhaps harm or at least less advantage to a growing child.

There is, therefore, a clear need for techniques to assist beleaguered parents in best meeting the nutritional requirements of one or more children, and assuring that the intended juvenile consumers receive the appropriate types of food and in the proper quantities for each stage of their development.

In addition, there is a further concern that a child or other charge may not receive a daily or regular requirement of various food groups recommended for that age or developmental level. Even if the food groups are known, there is a need for an improved mechanism to alert parents or caregivers on a recommended nutritional regimen and facilitate adherence to that regimen.

### SUMMARY OF THE INVENTION

The present invention is directed to systems and methodologies to facilitate the proper care and feeding of children or others by parents or caregivers. Through visual cues on products, juxtaposed with corresponding textual descriptors and color/texture-coding, the technique at the present invention provides a ready tool to identify appropriate foods for particular age, developmental or other groups. Additionally, a ring/band protocol establishes a way to assure that not only appropriate foods are consumed but in an appropriate percentage and amount to meet daily or weekly nutritional requirements, thereby assuring parents and other caregivers that their charges are properly fed.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Drawings, in which:

FIG. 1 illustrates an example of infant indicia and panel indicia employed pursuant to the teachings of the present invention, particularly showing a product suitable for an infant at a particular age or development level;

FIG. 2 illustrates another product for a different level of child development and the corresponding infant and panel indicia;

FIG. 3 illustrates another developmental level and the corresponding infant and panel indicia on a product label;

FIG. 4 illustrates yet another product label employing the infant and panel indicia pursuant to the teachings of the present invention;

FIG. 5 shows a further embodiment of the product label bearing the infant and owlet indicia of the present invention;

FIG. 5b shows a range of product labels bearing the child development and the corresponding infant and panel indicia.

FIG. 6 illustrates a ring system embodiment pursuant to the principles of the present invention, the ring system facilitating allocation of various daily requirement food groups, each ring representing one serving of a food group;

FIG. 7 illustrates a nutritional breakdown of a particular product using the ring paradigm of FIG. 6; and

FIG. 8 illustrates a nutritional breakdown of a particular menu plan pursuant to the teachings of the present invention.

### DETAILED DESCRIPTION OF THE PRESENT INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein. It should be noted that the present application relates to children up to the age of 10, including all references to “infants.”

As discussed, the present invention is directed to systems ad methodologies for facilitating parental or others obligations, particularly the feeding of children. The present invention accomplishes this important role by providing clear visual cues with associated text, illustrating the appropriateness and nutritional value of a particular food as it relates to an infant of a certain age. Following these visual cues, parents (or others tasked with like duties) can easily determine foods both nutritional and suitable for their child, thereby providing the proper diet for the developing youngster and alleviating stress on the parent.

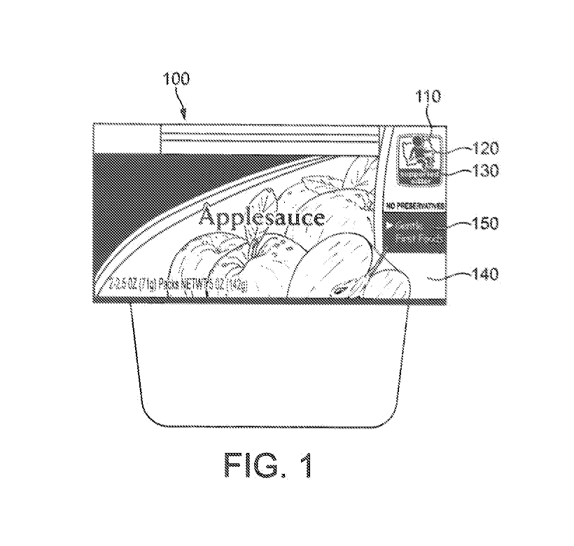

With reference to FIGS. 1-5b of the Drawings, there is illustrated a first embodiment of the present invention, where a visual paradigm proposed in the present in cation facilitates determining suitable foods for respective age and developmental ranges.

With reference now to FIG. 1 of the Drawings, there is illustrated a product label for baby food, generally designated by the reference numeral 100. Preferably, at a corner of the product label 100 is an infant indicia, generally designated by the reference numeral 110, which is part of a side panel indicia 140 described in more detail hereinbelow.

Infant indicia 110 has two components: a visual indicia and a corresponding textual indicia, generally designated by the reference numerals 120 and 130, respectively. As shown in FIG. 1, the food being offered for sale in this example is suitable for children that are somewhat able to sit up, i.e., a supported sitter, and text to that effect is shown in the textual indicia 130, along with the associated image of an infant at that stage, i.e., in the visual indicia 120, thereby providing a powerful tool for food suitability identification.

The juxtaposition of indicia 120 and 130 provide a simple mechanism for all parents and caretakers to select suitable foods. The infant indicia 110 provides a clear visual tool for parents, enabling them to quickly select foods appropriate for their child at a certain stage, without having to worry or contend with other, more complicated labels or research at the store.

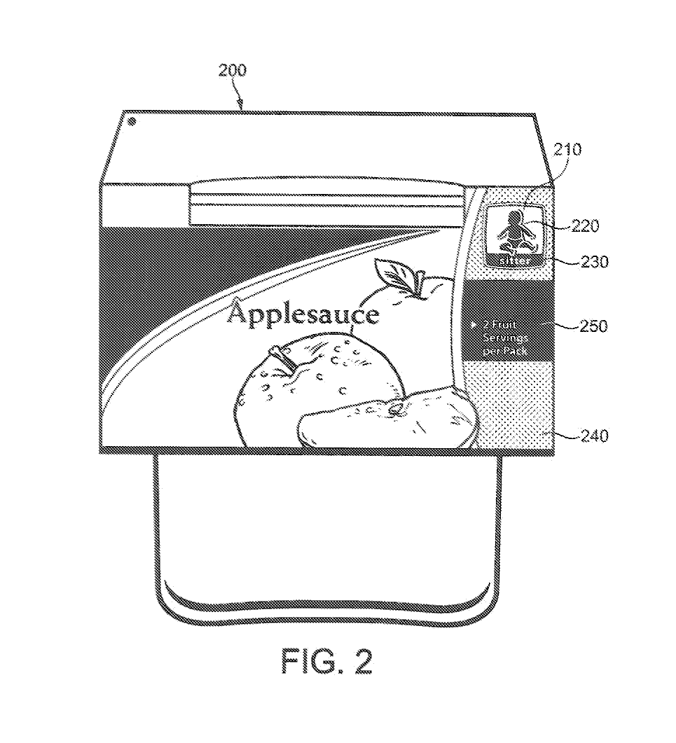

With reference now to FIG. 2, there is illustrated another exemplary product label, generally designated by the reference numeral 200, with an infant indicia 210 thereon, including a visual indicia 220 and a corresponding textual indicia 230.

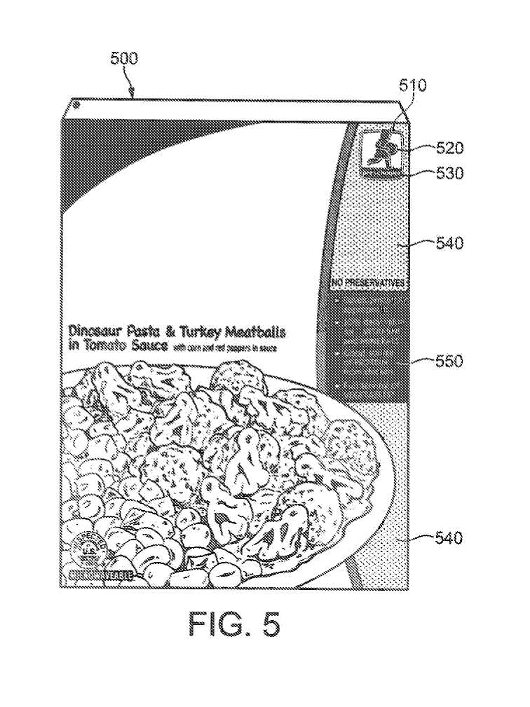

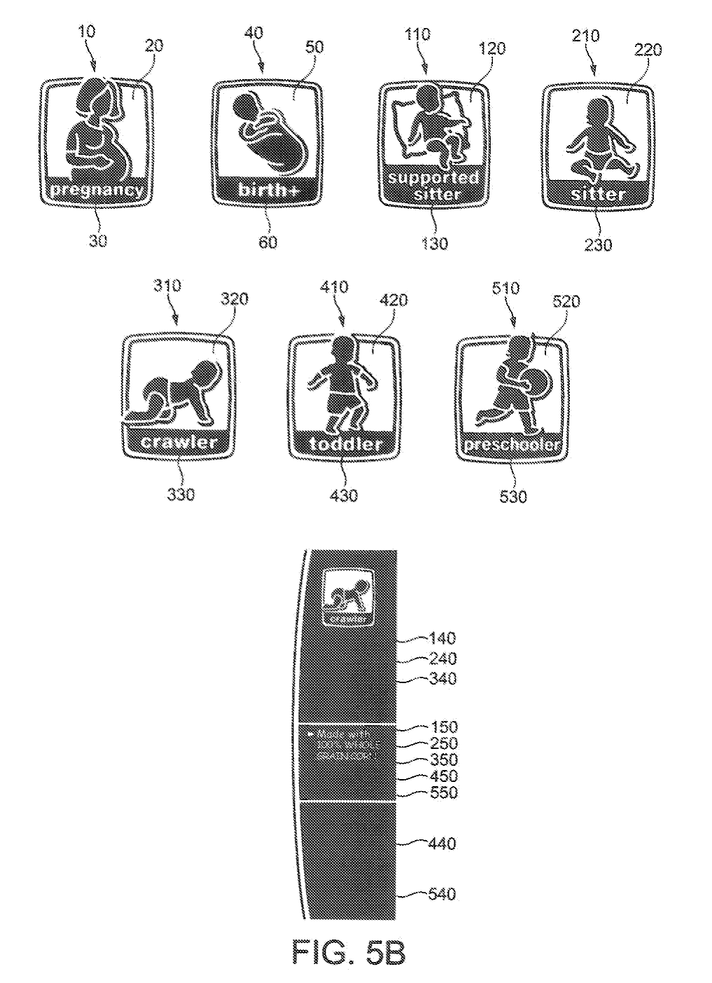

As before, the juxtaposition of the image and associated test provides a powerful cue as to appropriate level of infant development for the offered food product, e.g., a child that can sit up on their own, i.e., a sitter. Parents having a child at the sitter level can readily select the food so labeled from among other labels using the visual indicia 220 and/or the textual indicia 230. In stores, the various products and a product line for many differing ages and developmental levels can be sorted along the lines of such age and developmental growth using the visual indicia 220 as a sorting mechanism (see FIG. 5b).

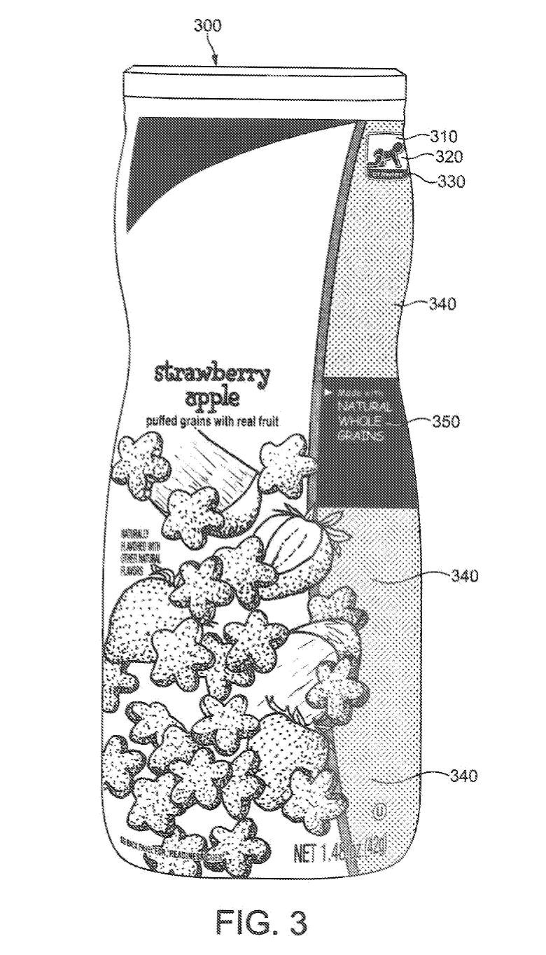

With reference now to FIG. 3, there is shown another product and product label, generally designated by the reference numeral 300. Also illustrated is an infant indicia, generally designated by the reference numeral 310, having a visual indicia 320 and a corresponding textual indicia 330.

As before, the image 320 and associated text 330 correspond to an infant developmental phase, i.e., an infant that crawls, a so-called “crawler.” Selection of suitable foods at this phase of development is made considerably easier by usage of the powerful cues in the infant indicia 310.

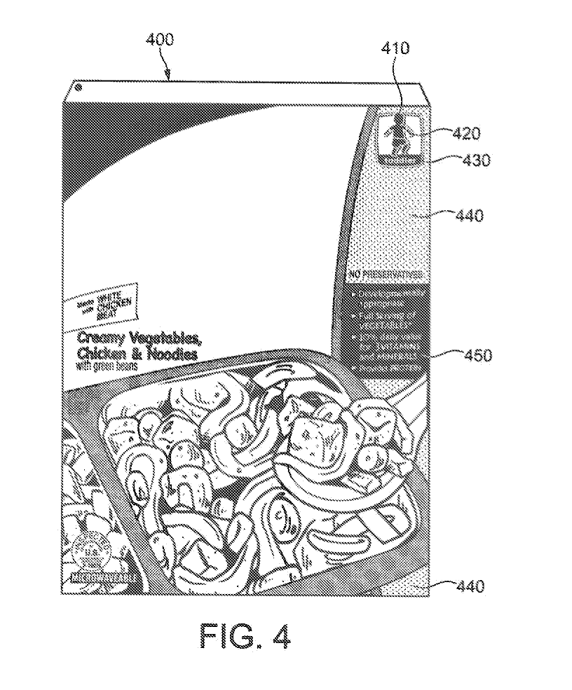

With reference now to FIG. 4, another product and product label are shown, generally designated by the reference numeral 400. An infant indicia 410 with visual indicia 420 and textual indicia 430 are also shown. Parents with walking children are thus able to easily select suitable foods for their newly-ambulatory child.

With reference now to FIG. 5, yet another product and product label are shown, generally designated by the reference numeral 300. An infant indicia 510 with visual indicia 520 and textual indicia 530 are also shown. Here, a chronological age description instead of a developmental period is provided, i.e., preschoolers, along with an image associated with a child in those years, thereby providing parents with readily discernable tools to select the appropriate food products for this level child.

Although the present application Figures are illustrated in black and white, it should readily be apparent that vivid coloration would be preferable and greatly assist in making visual gradations in products and nutritional values.

Although the aforementioned infant indicia provide one way to differentiate among food products for various children. Applicants propose an additional visual cue to accentuate differentiation further. For example, in FIGS. 1-5b, the right hand or side portion of the product label can alone constitute a visual cue as to the suitability of that product for an intended infant consumer, e.g., through use of color.

With reference again to the product label in FIG. 1, a side panel indicia 140 extends from the aforementioned infant indicia 110 at the top of the product label 100 down the side, providing another quite visible indicator of the suitability of that product for that age group, e.g., a yellow color indicating a supported sitter child level. Additional nutritional indicia 130 may also be employed to provide more information about the suitability of that product for that infant use group. Such information may included but is not limited to the oral and motor developmental attributes of the product such as taste and texture, the nutritional gap that the product fills and the fit of the product within the daily menu planning. As shown, images of the food product may overlay portions of the side panel indicia 140, but this should not be enough to obscure the visual cues. Additionally, elements of the color for that age group, e.g., yellow, can also be employed in the remainder of the product label, e.g., for aesthetic reasons, thereby further accentuating the color association in the minds of the parent or caregivers.

Similarly, in FIG. 2 a side panel indicia 240 (in light blue for sitters) indicates youngsters in that developmental range, and nutritional indicia 250 provide additional information. In FIG. 3, a side panel indicia 340 (bright red for crawlers) loudly indicates a suitable food product for children in that range, and nutritional indicia 350 provide additional information. In FIG. 4, a side panel indicia 440 (bright green for toddlers) signals foods for such children. Nutritional indicia 450 provide further information. Finally, in FIG. 5, a side panel indicia 540 (dark pink for preschoolers) indicates clearly the foods suitable for that age range, and nutritional indicia 550 provides more information.

Accordingly, the various visual cues employed in the present invention, i.e., the visual indicia of the infant, the associated textual descriptor, and the color-coded panel indicia each provide a powerful and mutually-reinforcing paradigm for product identification and differentiation, and product suitability for particular children and nutritional data. In FIG. 5b, one embodiment of the range of such product labels bearing the child development and the corresponding infant and panel indicia are shown.

It should be understood that each of the identification tools set forth in the present invention may be employed separately or in conjunction. It should further be understood that the color paradigm and indicia pairings set forth herein, when used together, provide a powerful product suitability recognition mechanism enabling a critical segment of the population (parents) a simplified, versatile and easy to understand approach to a critical function (feeding children). The particular colors employed for the developmental and age groups set further herein are exemplary, but, through use, may become standard as parents better identify and associate the color scheme, images and associated text to their child's needs.

As discussed, a benefit of the present invention is the ease of identification of suitable products among an array of product offerings of differing characteristics for each stage of development of a child. Allowing a parent or caregiver a simple and error-minimizing mechanism to differentiate among and choose the appropriate product is a boon for busy parents, and provides a benefit to the seller. Indeed, the usage of the side panel indicia, particularly color coded, draws the consumer's attention to the entire product line, conditioning the consumer for future sales, e.g., as the child progresses up the “food chain.” Displaying the various products in the product line alongside each other, with the various visual cues apparent, preferably in an ascending age order, would further accentuate the consumer's attention to the entire product line, readying the parent or caregivers to subsequent levels and assuring the parent that the needs of their child are met by this product, this product line, and this manufacturer.

It should, of course, be understood that the particular positionings of the indicia and side panels in the Figures illustrated herein is a preferred embodiment, and alternate positionings are clearly contemplated as within the scope of the present invention, e.g., the side panel along the left side, along the top or bottom, along the entire periphery of the label or alternate placings.

Similarly, the juxtapositioning of the visual and textual descriptions in the infant indicia, as relating to each other and the side panels, may be configured in alternate ways. Although Applicants believe that the particular positionings illustrated and described herein provide improved market recognition and association, alternate positionings may be employed without departing from the spirit of the present invention.

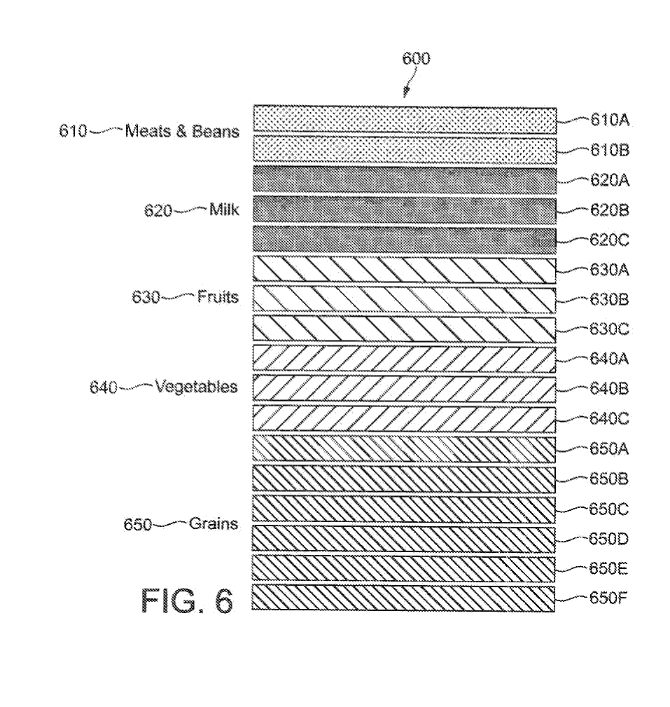

With reference now to FIGS. 6-8, there are illustrated therein another embodiment of the present invention, whereby more particular nutritional needs are addressed.

With particular reference to FIG. 6 of the Drawings, there is illustrated a system and methodology that would further assist parents or other caregivers on the nutritional value of respective products and the relationship of that value to the intended consumer of that product, e.g., an infant.

As noted earlier, parents and caregivers are beset by a deluge of information and opinions on the care and feeding of their children. Further, since the nutritional needs of children vary b) age and developmental change, parents often do not know what foods are suitable for their charges or how much food is suitable. With the rapid increase in obesity in the United States and many other countries, it is quite important that the developing child is given food not only appropriate to their age and developmental level, but in an amount and varying types conducive to developmental growth, but little or no more.

The infant and side panel indicia mechanism set forth hereinbelow in connection with FIGS. 1-5 provides a ready technique for parents to select appropriate food products for their child. The embodiments discussed hereinbelow in connection with FIGS. 6-8, however, further assist the parent or caregiver to govern the amount and types of food, of whatever product, for consumption.

Shown in FIG. 6 is an improved system and methodology, generally designated by the reference numeral 600, for facilitating the feeding of children or others. As illustrated, a number of sections or rings are employed, each representing a food type and a particular amount e.g., a serving. As is readily apparent, for developing children both the food type and the amounts thereof will vary, and parents and caregivers need a simple mechanism to ascertain the full suitability of a particular food for their child, i.e., can the child eat this and how much.

With further reference to FIG. 6, various rings are shown that represent particular food groups. It should be noted that the invention includes other embodiments of the rings, including but not limited to, pyramids, boxes, stickers, circles, triangles, cups and measuring spoon images. For example, for a product, such as any described and illustrated in connection with FIGS. 1-5, that product has a variety of food group designators associated therewith. In FIG. 6, there is shown an exemplary dietary regimen having five such food group designators: a meats and beans designator 610, a milk designator 620, a fruits designator 630, a vegetables designator 640 and a grams designator 650. It should, of course, be understood that designators 610-650 are exemplary food groupings, and numerous other potential groupings are apparent and understood to those of skill in the art. Also, although the embodiments set further in the present invention are directed primarily to child care, the principles of the present invention are equally suitable in the context of the care and feeding of other growing youngsters, e.g., babies, adolescents, pre-teenagers, and teenagers. Likewise, the teachings of the present invention may be used in the contact of elder care where dietary or other restrictions apply, e.g., no salt, no cholesterol, no fats, etc.

With further reference to FIG. 6, respective rings or rectangles represent a portion of a daily (or weekly or other regimen) serving requirement for each of the food group designators 610-650, more particularly, each ring represents a single serving for that age/developmental group. For example, the meats and beans designator 610 for this group has two rings, generally designated by the reference identifiers 610A and 610B, respectively. In this particular example, the two rings 610A and 610B each represent one serving of a daily serving requirement for an infant ages 1-4. Thus, an infant in this age range requires two servings of the meats and beans food category per day. The ring technique provides the parent with a visual clue of this requirement.

As further shown in FIG. 6, milk designator 620 has three rings associated therewith, generally designated by the reference identifiers 620A, 620B and 620C, respectively. Thus, an infant in this age range requires three servings of milk products per day. Similarly, the fruits designator 630 also has three rings associated therewith, generally designated by the reference identifiers 630A, 630B and 630C, respectively. The vegetables designator 640 also has three rings associated therewith, generally designated by the reference identifiers 640A, 640B and 640C, respectively. Finally, the grains designator 650 has six rings associated therewith, generally designated by the reference identifiers 650A, 650B, 650C, 650D, 650E and 650F, respectively. Thus, children in this age range require three servings of fruits, three servings of vegetables, and six servings of grains per day. Using this ring methodology, parents are on alert as to the nutritional requirements for this child and the degree a particular food or product offering meets that daily recommendation.

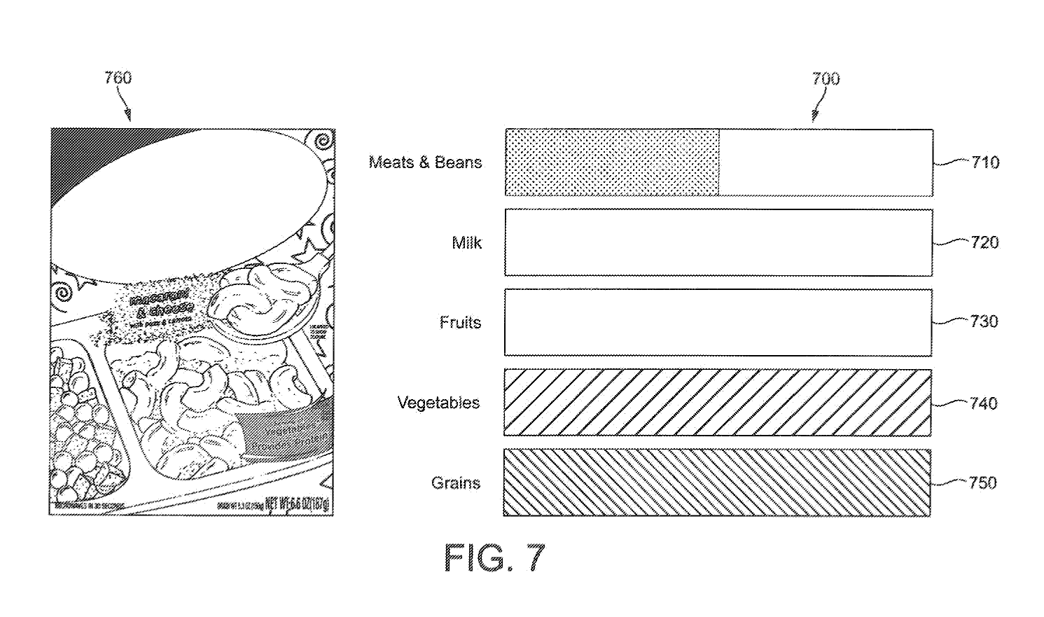

With reference now to FIG. 7 of the Drawings, there is illustrated a nutritional breakdown of a product using the ring protocol of the present invention, generally designated by the reference numeral 700. As shown, a product in this example, generally designated by the reference numeral 760, provides one half of a ring (one half serving) in a meats and beans ring 710, no servings of milk in the milk ring 720, no fruits in the fruits ring 730, one serving in a vegetables ring 740, and one serving in a grains ring 750. This breakdown provides parents or caregivers with a simple to understand methodology. Further, it is easy for them to calculate nutritional thresholds for their charge, and know the remaining nutritional needs for the child, e.g., that day. Parents can thus steer the child to products focusing on the unmet rings (food groups) in their age/development group.

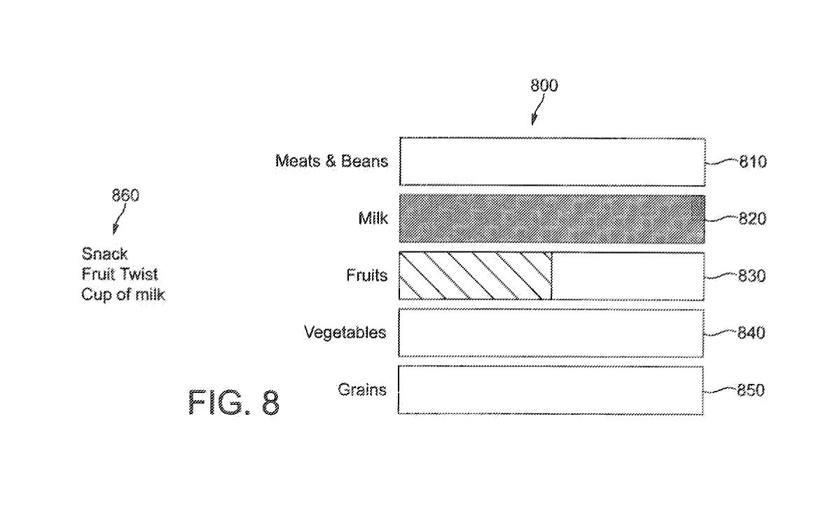

With reference now to FIG. 8 of the Drawings, there is shown a representative nutritional breakdown of a menu plan employing the graphical representation of the contents thereof in terms of servings of food groups, pursuant to the instant invention and generally designated by the reference numeral 800. As shown, a particular menu plan, generally designated by the reference numeral 860, includes a snack, fruit twist and a cup of milk. The nutritional breakdown of this plan, e.g., as provided by a school, is readily apparent using the tools of the present invention to indicate a full serving of milk (full milk ring 820) and a half serving of fruits (half filled fruits ring 830). The rings for meats and beans (810), vegetables (840) and grains (850) are empty, indicating that these nutritional elements are not present in this menu plan item. Clearly, the menu plan is not meant to meet the majority of the child's needs that day, and the empty rings must be filled by some other means.

Using the ring system of the present invention, parents and other caregivers can, e.g., using the daily serving requirements for the intended consumer, easily combine the rings to determine whether or not the daily (or other regimen) nutritional needs have been net for that individual. Parents can thus stack the rings to readily identify the particular nutritional information for their child, and add up the rings at the end of the day to determine the daily requirements. In this fashion, parents and other caregivers can be more assured that those they are responsible for are being properly fed to the best degree, providing a serenity of purpose and perhaps ease of guilt in this intensely personal endeavor.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A product label comprising:
a first indicia concerning a product; and
a second indicia, said second indicia including a text portion and a visual portion.
wherein said text portion comprises a descriptor of an intended user of said product, and
wherein said visual portion comprises a visual of said intended user, said descriptor of said intended use correlating to said visual of said intended user.

2. The product label according to claim 1, wherein said descriptor and said visual are adjacent on said product label.

3. The product label according to claim 2, wherein said descriptor and visual have differing features selected from the group consisting of color backgrounds and patterned backgrounds.

4. The product label according to claim 1, wherein said intended uses of said product is a child, said descriptor and visual in said second indicia corresponding to a stage of development of said child.

5. The product label according to claim 4, wherein said stage of development of said infant is selected from the group consisting of supported sitter, sitter, crawler, walker, toddler, preschooler and up to age 8 years.

6. The product label according to claim 1, further comprising:
a panel indicia, said panel indicia extending substantially along an edge of said product label.

7. The product label according to claim 6, wherein said second indicia is substantially overlaid within said panel indicia.

8. The product label according to claim 6, wherein said second indicia includes a second descriptor.

9. The product label according to claim 8 wherein the second descriptor identifies information selected from the group consisting of product nutritional information and product developmental information.

10. The product label according to claim 1, further comprising:
a third indicia, said third indicia comprising a plurality of symbols,
wherein each said plurality of rings corresponds to respective daily serving portions for an intended user of said product; and
wherein the respective amounts of said daily serving portions of said product are shown in respective rings.

11. The product label of claim 10 wherein each of the plurality of symbols have a different color or pattern.

12. The product label of claim 10 wherein the plurality of symbols are selected from the group consisting of rings, boxes, circles, triangles, cups, measuring spoons, bottles, compass and pie charts.

13. A methodology for product labeling, comprising:
affixing a first indicia on a product or a product label,
affixing a second indicia on said product or said product label, said second indicia comprising a text portion and a visual portion,
wherein said text portion comprises a descriptor of an intended user of said product and
wherein said visual portion comprises a visual of said intended user, said descriptor of said intended use correlating to said visual of said intended user.

14. The method according to claim 13, further comprising:
affixing a panel indicia on said product label, said panel indicia extending substantially along an edge of said product label.

15. A product label comprising:
a first indicia concerning a product; and
a second indicia said second indicia including a plurality of rings;
wherein each said plurality of rings corresponds to respective daily serving portions for an intended user of said product; and
wherein the respective amounts of said daily serving portions of said product are shown in respective rings.

16. The product label according to claim 15, wherein said plurality of rings correspond to respective food groups.

17. The product label according to claim 16, wherein each food group of said rings is selected from the group consisting of meats, beans, milk, fruits, vegetables and grains.

18. The product label complies to claim 17, wherein the respective food groups are differentiated by color coding in the respective rings.

19. A product label comprising:
a panel indicia on said product label, said panel indicia being one of a group of colors allocated for employment on said panel indicia, said groups of colors corresponding to respective stages of infant development, said one color corresponding to a particular stage of childhood development;
at least one other indicia on said product label, said at least one other indicia being one of a group of shapes allocated for employment on said product label with said panel indicia, said at least one other indicia corresponding to the same childhood development stage corresponding to said one color,
whereby said one color and said at least one other indicia both represent the same childhood development stage and the association therewith is reinforced in the mind of the buyer of the product using said product label.

20. A product label comprising:
a ring indicia on said product label, said ring indicia comprising at least one ring, each said ring corresponding to respective daily serving portions for an intended user of the product using said product label, respective amounts of said daily portions of said product being shown in respective ones of said at least one ring;
at least one other indicia on said product label, said at least one other indicia being one of a group of representations allocated for employment on said product label with said ring indicia, said at least one other indicia corresponding to the same intended user, said intended user having a development stage associated with said ring indicia and said at least one other indicia,
whereby said ring indicia and said at least one other indicia both represent the same development stage of said intended user and the association therewith is reinforced in the mind of the buyer of the product using said product label.
